(19) United States
(12) Patent Application Publication
(10) Pub. No.: US 2004/0068716 A1
(43) Pub. Date: Apr. 8, 2004

(54) Retargetable compiler for multiple and different hardware platforms

(75) Inventor: Cameron Stevens, Bainbridge Island, WA (US)

Correspondence Address: NANCY R. GAMBURD, MUCH SHELIST FREED DENENBERG AMENT&RUBENSTEIN,PC, 191 N. WACKER DRIVE, SUITE 1800, CHICAGO, IL, 60606-2877, US

(73) Assignee: Quicksilver Technology, Inc.

(21) Appl. No.: 10/264,485

(22) Filed: Oct. 4, 2002

(51) Int. Cl. G06F 9/45

(52) U.S. Cl. 717/140

(57) ABSTRACT

The invention provides a compiler for generating assembly or configuration instructions from source code for an integrated circuit architecture of a plurality of different IC architectures. The source code is represented as a plurality of nodes of an abstract syntax tree. For each target architecture, a plurality of concrete instruction tiles are generated as concrete classes corresponding to and inheriting from a plurality of function tiles. Each function tile is implemented as an abstract class, represents a corresponding function, such as an ADD or MULT function, and implements a matching operation for the corresponding function. The compiler includes an instruction selector, formed as an abstract class, which implements a matching function and instruction generation for the abstract syntax tree by calling the corresponding matching operations of the concrete instruction tiles, inherited from the plurality of function tiles. When a concrete instruction tile or corresponding function has been matched to a node of the abstract syntax tree, the instruction selector calls an instruction generation function of the corresponding concrete instruction tile to generate an instruction for the corresponding IC architecture. By varying the concrete instruction tiles, the compiler may be targeted to any IC architecture.

### FIELD OF THE INVENTION

The present invention relates, in general, to compilers utilized to convert source code into a machine assembly language and, more particularly, to a retargetable compiler for multiple and different hardware platforms, such as for various microprocessors, digital signal processors, and adaptive computing platforms.

### BACKGROUND OF THE INVENTION

Compilers are utilized in the process of converting source code into machine assembly language and, ultimately, into a binary code for execution by a processor, such as a microprocessor or digital signal processor (“DSP”). Compilers may generally be divided into three major parts or stages known as a front end, a back end, and an optimizer. Following the third stage of optimization, discussed below, an additional stage converts the assembly code into binary code to be used in the selected, specific hardware architecture.

The first stage or front end of a compiler translates or parses source code into an internal representation which it can analyze, such as an abstract syntax tree used to capture the expressions described in the source code. The compiler front end further analyzes the source code to determine whether it is structurally correct, making sure that the syntax requirements of the source language are followed, such as the grammar requirements of C++. In addition, the compiler front end also performs a semantic analysis of the source code to determine whether the source code is meaningful, i.e., that the source code makes sense.

The second stage or back end of a compiler, using a representation such as the abstract syntax tree generated by the first stage, analyzes and transforms the representation into an assembly language code, consisting of unscheduled assembly language instructions (e.g., MOVE data from memory to a register, ADD, MULT, and so on). In doing so, this back end process also may provide improvements to the representation (abstract syntax tree), such as removing redundancies. Many compilers, for the second stage, utilize a well-known algorithm referred to as “Maximal Munch”. See, e.g., Glanville, R. S., A Machine-Independent Algorithm of Code Generation and its Use in Retargetable Compilers, Ph.D thesis, The University of California at Berkeley, 1978. While the Maximal Munch algorithm itself is independent of any given hardware (i.e., integrated circuit or “IC”) architecture, in the prior art, its application within the second stage is completely specific to a selected hardware architecture.

More particularly, in the prior art, this assembly language code from the second stage of compilation is highly specific or native to a selected hardware architecture, and cannot be utilized with any other architecture. As a consequence, a completely separate and different compiler is utilized to convert high-level source code into a given assembly language specific to a corresponding hardware architecture, even though these different compilers may be implementing the same or similar algorithms. For example, corresponding and completely separate compilers are utilized to generate assembly language code: which is completely specific to an Intel x86 or Pentium processor architecture; or which is completely specific to a Texas Instruments DSP architecture; or which is completely specific to a Motorola M68000-series processor architecture; or which is completely specific to an adaptive computing architecture. In the prior art, a compiler for one of these architectures is completely useless and meaningless for any other architecture.

The third stage of the compiler, the optimizer, converts the unscheduled code from the second stage into scheduled instructions. For example, the optimizer will determine which registers and which parts of memory of the specific architecture are to be used at any given time, and will determine the order of computations. In addition, the optimizer may reorder the computations. As mentioned above, these scheduled instructions are then converted into a binary form, for use in the specific hardware architecture.

### SUMMARY OF THE INVENTION

An exemplary embodiment of the compiler of the present invention is implemented using object-oriented techniques, for generating assembly or configuration instructions from source code for one or more integrated circuit architectures of a plurality of integrated circuit architectures, such as for a first integrated circuit architecture or for a second integrated circuit architecture. The source code is generally represented as a plurality of nodes of an abstract syntax tree. The compiler comprises an instruction selector, a plurality of function tiles, and a first plurality of concrete instruction tiles corresponding to the plurality of function tiles (for a first integrated circuit architecture). In targeting additional architectures, other sets of concrete instruction tiles are utilized, with each set corresponding to a selected IC architecture.

The instruction selector is formed as an abstract class, and is capable of performing a matching function for the plurality of nodes, as discussed below. This matching function is part of a larger process of generating instructions for a target integrated circuit architecture.

The plurality of function tiles are formed as abstract classes. Each function tile represents a corresponding function, such as an add, move, or multiply function, and is capable of performing a matching operation for the corresponding function. The function tiles are not, however, capable of generating instructions and, as a consequence, are independent of any integrated circuit architecture.

The first plurality of concrete instruction tiles are formed as concrete classes corresponding to and inheriting from the plurality of function tiles. As extensions of the plurality of function tiles, the first plurality of concrete instruction tiles instantiate the matching operations of the corresponding plurality of function tiles. Each concrete instruction tile (of the first plurality of concrete instruction tiles) is capable of generating an instruction for the first integrated circuit architecture when a corresponding function has been matched to a node of the plurality of nodes.

More particularly, the instruction selector is capable of performing the matching function by iteratively calling corresponding matching operations of the first plurality of concrete instruction tiles inherited from the corresponding plurality of function tiles. The instruction selector is further capable of performing instruction generation for the first integrated circuit architecture, when the corresponding matching operation of a concrete instruction tile of the first plurality of concrete instruction tiles indicates that a corresponding function has been matched to a node of the plurality of nodes, by calling an instruction generation function of the corresponding concrete instruction tile of the first plurality of concrete instruction tiles. The instruction selector repeats this process (recursively), continuing the matching and instruction generation functions on the sub-tree(s) defined by the nodes not yet matched, until all nodes of the abstract syntax tree have been matched.

To target the compiler to a second architecture, a second plurality of concrete instruction tiles corresponding to and inheriting from the plurality of function tiles is utilized. Each concrete instruction tile (of the second plurality of concrete instruction tiles) also instantiates the matching operation of the corresponding plurality of function tiles, and is capable of generating an instruction for the second integrated circuit architecture, of the plurality of integrated circuit architectures, when a corresponding function has been matched to a node of the plurality of nodes.

The instruction selector is further capable of performing a tile set generation function, to produce the various concrete tile sets for the different architectures, using various concrete instruction selectors extending the instruction selector to corresponding integrated circuit architectures. The concrete instruction selectors implement the tile set generation function by determining the pluralities of concrete instruction tiles for corresponding integrated circuit architectures.

An instruction tile, formed as an abstract class and as a base class of the plurality of function tiles, declares a plurality of operations for use by the plurality of function tiles, the plurality of concrete instruction tiles, and the instruction selector in performing the matching function, and in sorting the plurality of concrete instruction tiles (or, equivalently, the plurality of function tiles) in order of descending size (to, for example, implement a Maximal Munch pattern-matching algorithm). The plurality of operations comprise one or more of the following functions: a Boolean matching function, an assembly instruction generation function, a tile size function and a compare function.

In an exemplary embodiment, the instruction selector is capable of performing the matching function by iteratively calling the Boolean matching functions of the plurality of concrete instruction tiles (inherited from the plurality of function tiles) and, when a match of a concrete instruction tile to a node has occurred, by calling the instruction generation function of the corresponding concrete instruction tile.

The exemplary compiler may be targeted and retargeted for a plurality of integrated circuit architectures by utilizing different sets of concrete instruction tiles. For example, the same compiler, with corresponding sets of concrete instruction tiles, may generate assembly instructions for a first integrated circuit architecture having a fixed microprocessor architecture, and a second integrated circuit architecture having a fixed digital signal processor architecture. Furthermore, the same compiler, with another corresponding set of concrete instruction tiles, may generate configuration instructions for a third integrated circuit architecture which is an adaptive computing architecture, wherein the configuration instructions are capable of reconfiguring an interconnection network of the adaptive computing architecture for a selected functionality.

Numerous other advantages and features of the present invention will become readily apparent from the following detailed description of the invention and the embodiments thereof, from the claims and from the accompanying drawings.

### BRIEF DESCRIPTION OF THE DRAWINGS

The objects, features and advantages of the present invention will be more readily appreciated upon reference to the following disclosure when considered in conjunction with the accompanying drawings, in which:

FIG. 1 is a diagram illustrating an exemplary abstract syntax tree representation and corresponding source code.

FIG. 2 is a diagram illustrating the exemplary abstract syntax tree representation of FIG. 1 with a first instruction set tiling.

FIG. 3 is a diagram illustrating the exemplary abstract syntax tree representation of FIG. 1 with a second instruction set tiling.

FIG. 4 is a flow diagram with abstract classes and concrete instruction tiles of a retargetable object-oriented compiler in accordance with the present invention.

### DETAILED DESCRIPTION OF THE INVENTION

While the present invention is susceptible of embodiment in many different forms, there are shown in the drawings and will be described herein in detail specific embodiments thereof, with the understanding that the present disclosure is to be considered as an exemplification of the principles of the invention and is not intended to limit the invention to the specific embodiments illustrated.

The compiler of the present invention uses a novel and innovative object-oriented design that facilitates efficient retargeting of its instruction selector to multiple and different hardware and assembly language platforms. The implementation of the invention defines and utilizes “abstract classes” that provide the majority of the functionality for the second stage of compilation, such as for use of the Maximal Munch algorithm, along with defining and using abstract “instruction tiles” for the matching operations in transforming the abstract representation into instructions. When targeting or retargeting the compiler to any given hardware architecture or platform, corresponding “concrete classes” are defined and utilized to inherit all functionality from the higher-level abstract classes, and with only the additional specification of new or other functionality that is particular to the given hardware platform. These specialized concrete classes are then used to generate or emit the instructions specific to the given hardware platform.

As used herein, targeting and retargeting have their usual and customary meanings, such as adapting or specializing, and readapting or respecializing. “Assembly language”, “assembly instructions”, “assembly-level instructions”, or simply “instructions”, have a broader and more inclusive meaning to, for example, include configuration instructions for adaptive IC architectures which are similarly at an assembly-level but which are not strictly processor-based “assembly” code instructions. For example, when the target integrated circuit architecture is an adaptive computing architecture, the generated instructions are configuration instructions capable of reconfiguring an interconnection network of the adaptive computing architecture for a selected functionality.

“Abstract” class and “concrete” class, as used herein, also have their usual and customary meaning. For example, an abstract class has at least one method (itself or through inheritance) which, although it may be specified (e.g, what the method will do), is not implemented (e.g., how it will do the method). In contrast, for a concrete class, it either implements the methods itself, or inherits implemented methods, with no methods or functions remaining unimplemented (abstract). As a consequence, and as discussed in greater detail below, the function tiles of the invention are abstract, because while implementing a matching operation for a particular function, they do not implement the remaining instruction generation function inherited from the base class, Instruction Tile, while the concrete instruction tiles are concrete, implementing the instruction generation function, with no functions or methods, within its own class or within an inherited class, remaining to be implemented.

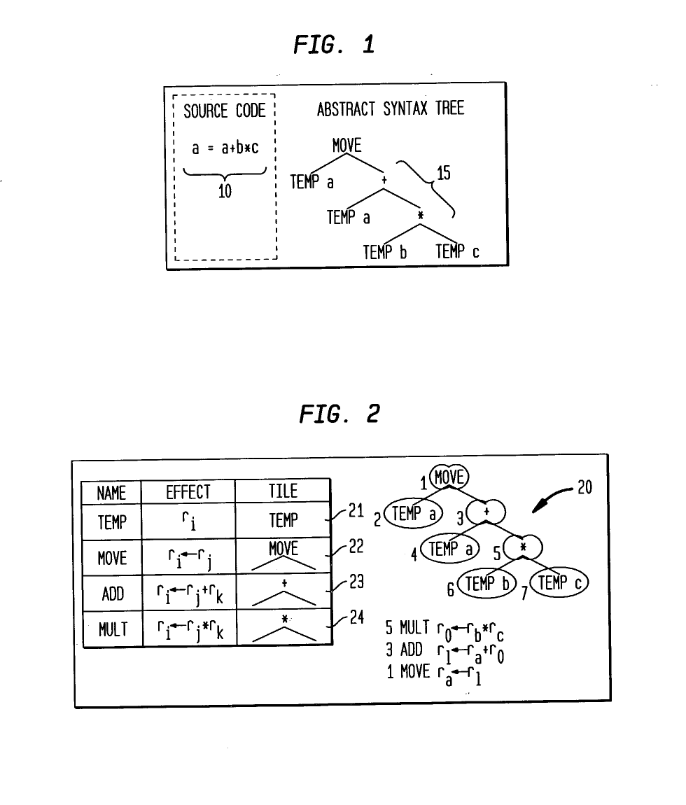

FIGS. 1, 2 and 3 provide background information to facilitate understanding of the present invention. Throughout this specification, the well-known convention of using a Courier font type will be utilized to designate program (or software) code, program names, and various other program identifiers.

FIG. 1 is a diagram illustrating an exemplary (albeit simple for explanatory and illustration purposes) abstract syntax tree representation and corresponding source code. As illustrated in FIG. 1, exemplary source code (10) “a=a+b*c” is transformed, by a compiler first stage (front end), into an abstract syntax tree (15), for further use in the second stage of compilation. The abstract syntax tree 15 illustrates subdividing the source code 10 (into sub-trees, branches, etc.) into a representation of single steps (nodes) for execution of corresponding functions and with corresponding memory (or register) variables.

In general, the instruction selection process proceeds to generate instructions for the target platform by recursively matching nodes (or sub-trees of several nodes) of the abstract syntax tree 15 generated by the compiler front end against “instruction tiles”. The instruction tiles provide for issuing (or emitting) corresponding assembly instructions. When a match between the node and an instruction tile is found, the instructions corresponding to the matching tile are stored temporarily and the tiling operation continues on the sub-tree(s) defined by the nodes not covered by the matching tile(s). Note that the instructions for the sub-tree(s) are emitted before the instructions generated for the matching tile. The Maximal Munch matching algorithm is a “greedy” algorithm, and proceeds from the root of the abstract syntax tree and always chooses the largest possible matching tile.

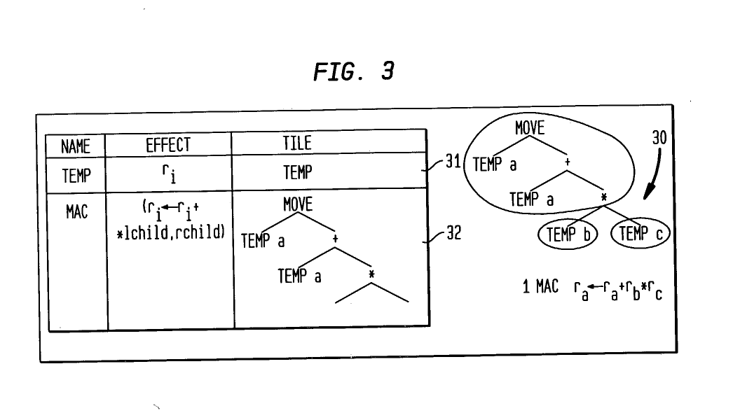

FIG. 2 is a diagram illustrating the exemplary abstract syntax tree representation of FIG. 1 with a first instruction set tiling 20. For this example, the tile set consists of the tiles TEMP (21), MOVE (22), ADD (23), and MULT (24). The matching algorithm begins by matching the MOVE tile (22) at the node (1) at the root of the tree. In this case, the MOVE tile (22) will recurse to match its left and right children (as nodes 2 and 3) to obtain their corresponding instructions, emit them, and then emit its own assembly instructions. The left and right children will in turn be matched against the TEMP (21), ADD (23), and MULT (25) tiles (for nodes 2 through 7), and so on.

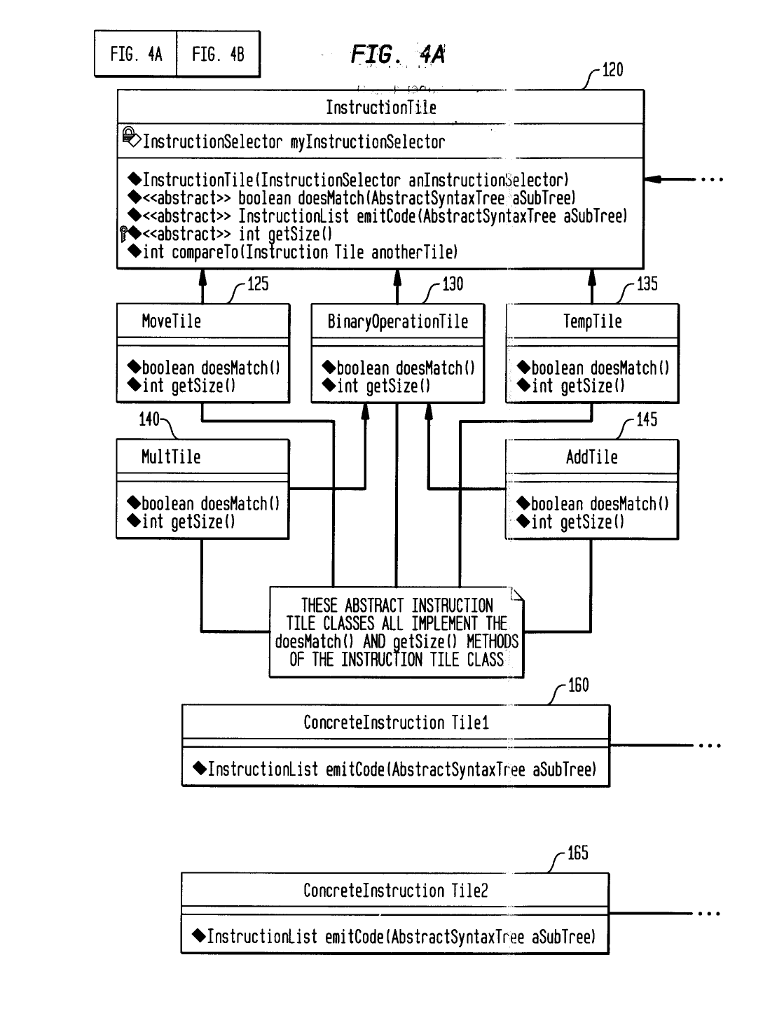

FIG. 3 is a diagram illustrating the exemplary abstract syntax tree representation of FIG. 1 with a second instruction set tiling 30, using a second, alternate tile set (and the instructions that are emitted) in conjunction with the Maximal Munch matching algorithm. This second instruction tile set includes availability of a larger instruction tile, multiply-and-accumulate (MAC) 32 which allows immediate matching of much larger portion of the syntax tree.

FIG. 3 further illustrates significant properties used to advantage in the present invention. First, in many instances, the source code language (e.g. C++) is the same or fixed, independently of any hardware architecture, and may be implemented in any appropriate platform. As a consequence, the resulting abstract syntax tree is generally also the same, also regardless of hardware architecture. The pattern matching algorithm and the resulting pattern of the matched instruction tiles also may remain constant, or very similar (depending upon the availability of certain matching tiles such as MAC), regardless of the target hardware architecture. In accordance with the present invention, in addition to the availability of certain tiles in certain architectures, the only distinguishing features between the balance of the various tile sets will be the instructions they ultimately emit, using concrete classes, as discussed in greater detail below.

The Abstract Classes and Concrete Classes of the Invention:

The present invention focuses on an instruction selection phase (or part) of the compilation second stage (back end). The instruction selection phase employs pattern-matching techniques to match portions (one or more nodes) of the abstract syntax tree generated by the compiler front end with two main types of instruction tiles. In the invention, such instruction tiles used for pattern matching are divided into two separate types of tiles, abstract tiles and concrete tiles, referred to as function tiles (or abstract instruction tiles) and concrete instruction tiles, respectively.

Each such abstract instruction (or function) tile represents a particular function, such as an add, multiply, or move function, and includes a matching operation or function to determine whether its represented function, as a pattern, matches one or more nodes (or sub-trees) of the abstract syntax tree. These abstract instruction tiles are implemented using abstract classes, as mentioned above. Each such abstract instruction (or function) tile corresponds to, but does not generate, one or more instructions required to implement the function(s) on any hardware platform. Following a match of the corresponding function to a node of the syntax tree, a corresponding concrete instruction tile for the selected architecture will generate or emit the instruction(s) corresponding to the represented function of the matched abstract instruction tile.

These corresponding concrete instruction tile sets, utilizing concrete classes that are extensions of and inherit from the abstract instruction tiles (function tiles), may be developed for each desired or selected hardware platform (or assembly language), and are utilized to generate instructions for the corresponding hardware platform. As a consequence, this second stage of the compiler of the invention is retargetable to any hardware architecture by selecting an appropriate set of concrete instruction tiles. (“Tile” or “Tiles”, as used herein, have their usual and customary meaning as known in the various computing arts and sciences, such as meaning a “matching sub-tree” or a pattern which describes an ordered set of operations with a tree-form of data structure.)

More particularly, the second stage of compiling may be represented as two phases or aspects, a matching phase and a code emitting phase, in accordance with the present invention. In the matching aspect, a matching algorithm (such as Maximal Munch) is implemented. The instruction tiles used in the matching phase of the invention, namely, the abstract instruction tiles (implemented as abstract classes), are generally the same, independently of any hardware architecture. These tiles of the matching phase of the present invention, as abstract tiles, do not emit instructions, in contrast with the prior art. Rather, the instructions are emitted in a second aspect, using concrete tiles for a selected hardware architecture, which are not independent of the platform.

These two aspects are accomplished by iteratively matching the concrete instruction tiles with the abstract syntax tree, with an instruction selector calling a matching operation of a concrete instruction tile inherited from the corresponding abstract function tile. (This matching operation may be equivalently considered to be matching the concrete instruction tile itself (through its inheritance from and instantiation of the corresponding function tile), matching the corresponding abstract function tile implementing the matching operation, or matching the corresponding function represented by the function tile and inherited by the corresponding concrete instruction tile, as each description constitutes or represents the same functional match of an instruction to the appropriate node of the syntax tree.) When a match is found, however described, instruction generation for the particular architecture occurs by calling an instruction generation function of the corresponding concrete instruction tile.

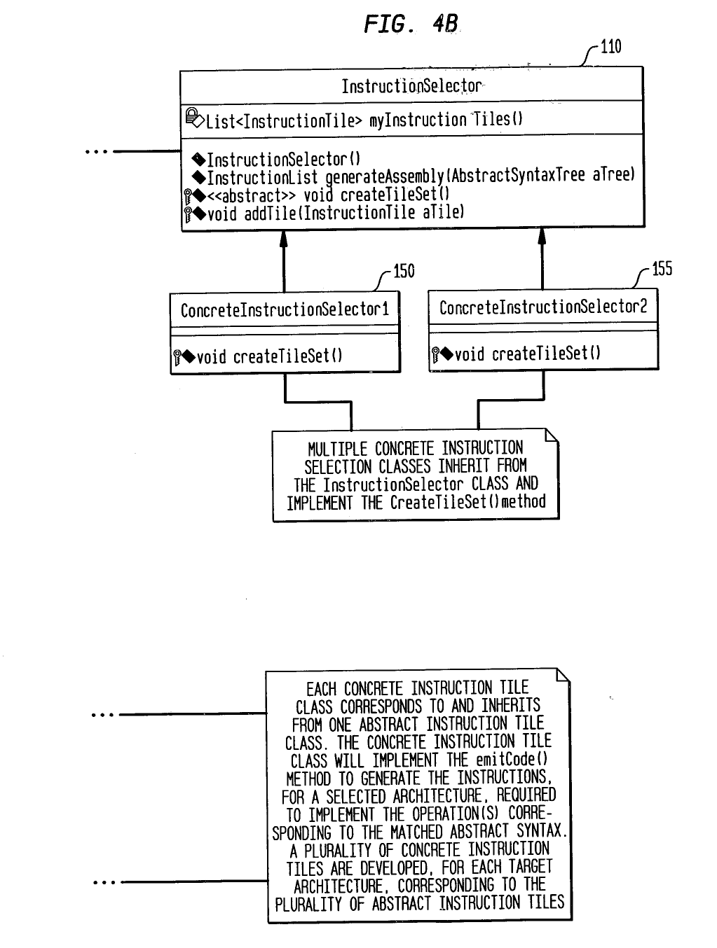

FIG. 4 is a flow diagram illustrating exemplary abstract tiles, abstract classes, concrete classes, and concrete instruction tiles, with explanatory notes and with arrows indicating inheritance (from a higher-level, parent or base class), of a retargetable compiler in accordance with the present invention. A separate, abstract instruction selector class (110) is utilized to generate a set of matching tiles for use in the matching algorithm, defined as having an abstract method referred to as “createTileSet( )” (where “void” means that the method does not return a value). When a target platform is selected, such as an Intel processor or an adaptive computing engine, a concrete instruction selector (150, 155) implements the createTileset ( ) method, and chooses particular concrete instruction tiles (e.g., 160, 165) for that corresponding, selected platform, using an “addTile ( )” call (or function) inherited from the higher-level, abstract instruction selector class 110. As a consequence, different sets of concrete tiles may be generated to correspond to different hardware platforms. These concrete tiles will then be utilized to emit corresponding, architecture-specific instructions for a selected platform. Different sets of concrete instruction tiles enable the compiler of the invention to be targeted or retargeted to any selected integrated circuit architecture, providing polymorphism within the compiler implementation.

This targeting or retargeting of the compiler of the invention may occur at any time. For example, selection of a hardware platform may occur at run time, with targeting (or retargeting) implemented by selecting (or switching to) the concrete instruction selector and concrete instruction tiles corresponding to the selected or targeted hardware architecture, thereby producing corresponding, unscheduled instructions.

This use of classes for a compiler, and more particularly, abstract and concrete classes, with inheritance of functionality, is a marked departure from prior art compilers. In general, compilers have never departed significantly from their legacy structures and have never used this object-oriented structure with classes. Prior art compilers, more particularly, have never utilized an object-oriented structure having both abstract and concrete classes, viewing such a compiler structure as inefficient, unwieldy, and unnecessary.

Referring to FIG. 4, the abstract classes include: an instruction selector class 110 (InstructionSelector) that implements the (Maximal Munch) pattern-matching algorithm; and an instruction tile class 120 (InstructionTile) that declares (but does not define) the methods that all instruction tiles must implement (such as pattern matching and instruction generation). Also embodied using abstract classes are several exemplary abstract instruction tiles (function tiles) (125, 130, 135, 140, and 145), which are extensions or derivations of (and which inherit from) the base or parent instruction tile class 110 (InstructionTile), and which implement pattern matching for sub-trees or nodes that commonly appear in abstract syntax trees (such as MultTile 140). As illustrated, these abstract instruction tiles (formed as or implemented by abstract classes) all implement the doesMatch ( ) and getsize ( ) methods of the InstructionTile class 120, thereby implementing the functions required to match some sub-tree of an abstract syntax tree (with getSize ( ) used in the size ordering of the Maximal Munch pattern matching). The exemplary abstract instruction tiles have corresponding functions (or patterns) for use in performing the pattern matching, such as a move function (125), an add function (145), a multiply function (145), and so on. Additional such abstract classes may be defined, each of which will represent a corresponding function and will be responsible for matching some pattern of an abstract syntax tree.

The concrete classes include InstructionSelector-derived classes, such as concrete instruction selectors 150 and 155, that perform instruction selection for a particular, corresponding target architecture (Concrete InstructionSelector1 150 and ConcreteInstructionSelector2 155). With regard to the concrete InstructionSelector-derived classes 150 and 155, additional concrete classes may be defined which, like classes 150 and 155, inherit from the InstructionSelector class and implement the createTileSet ( ) method, thereby forming the concrete tile set applicable to a given hardware platform.

Also implemented as concrete classes are several concrete instruction tiles (classes) 160 and 165 that instantiate and inherit from the abstract InstructionTile-derived classes described above. Similarly, multiple concrete instruction tiles or classes (and versions) similar to the concreteInstructionTile1 (160) and concreteInstructionTile2 (165) may be defined which extend and inherit from higher-level abstract classes (instruction tile 120 and the various function tiles 125, 130, 135, 140 and 145). These concrete instruction tiles provide an instruction generation function, such as implementing the emitCode ( ) method, to generate hardware-specific instructions required to implement the functions or operations corresponding to the matched abstract syntax (matched via a corresponding abstract instruction (function) tile). A novel and innovative result of this invention is that the concrete classes need only implement the methods to emit the appropriate instructions when they (through their higher-level abstract classes or tiles) are matched against an abstract syntax tree. They do not need to implement pattern-matching operations.

The InstructionTile class 120 is illustrated in FIG. 4, and is an abstract class that defines all the operations that are required by the InstructionSelector class 110 in order to perform tiling. The (Boolean) doesMatch ( ) method returns true when a tile matches the sub-tree passed as an argument. When this occurs, the emitCode ( ) method will be called to generate the (assembly-level) instructions corresponding to the matched sub-tree. The getSize ( ) method is used by the compareTo ( ) method that is called when the InstructionSelector 110 sorts the tiles in order of descending size (e.g., for Maximal Munch). The doesMatch ( ) method for an exemplary abstract function tile of FIG. 4 (MoveTile 125) is:

boolean MoveTile::doesMatch(AbstractSyntaxTree aSubtree)

{

if (aSubTree instanceof MoveStatement)
{

return true;

}
return false;

}

Similar doesMatch ( ) methods are illustrated below for other exemplary function tiles (BinaryoperationTile 130, TempTile 135, MultTile 140 and AddTile 145). These function tiles are implemented as abstract classes, inheriting from the InstructionTile 120, with each function tile implementing an matching operation (doesMatch ( )) for its corresponding function, such as the corresponding functions of move, binary operation, add, temp, multiply, and so on. While expressed as functions such as add and multiply, it should be noted that each such function is representative of an abstract syntax pattern, such that it is this pattern which is matched to a node (or nodes) of the abstract syntax tree.

Concrete instruction tiles are defined, as concrete classes, for the target or selected IC architecture. Each concrete instruction tile corresponds to and inherits from an abstract function tile, instantiating the matching operation for the corresponding function of the abstract instruction tile. In addition, each concrete instruction tile includes an instruction generation function, such that when its corresponding function (or, equivalently, the concrete instruction tile itself or its corresponding function tile) is matched to one or more nodes of the abstract syntax tree, an instruction is generated (emitted) for the selected architecture.

The instruction selector (InstructionSelector) class 110 implements an exemplary pattern-matching algorithm such as Maximal Munch, as a matching function (as part of a larger operation of generating instructions, as illustrated in the code below). For a given abstract syntax tree, it iterates over all the tiles in its myInstructionTiles collection. These tiles are the concrete instruction tiles, which inherit from and instantiate the matching operation of the corresponding abstract instruction tile, and which generate instructions. The InstructionSelector iterates over these concrete instruction tiles, calling the doesMatch ( ) method of each tile (inherited from the corresponding abstract instruction tile). When the instruction selector encounters a match (i.e., a matching function or matching tile) to one or more of the nodes of the abstract syntax tree, the instruction selector calls the emitCode ( ) method of that matching concrete instruction tile, and returns the resulting assembly or configuration instructions. This instruction selection process may be illustrated as:

InstructionList InstructionSelector::generateAssembly(

AbstractSyntaxTree aSubTree)

{

Iterator iterator = myInstructionTiles.iterator( );
while (iterator.hasNext( ))
{

InstructionTile aTile = (InstructionTile) iterator.next( );
If (aTile.doesMatch(aSubTree))
{

return aTile.emitCode(aSubTree);

}

}

}

The InstructionSelector class 110 defines the createTileSet ( ) method as abstract. This forces concrete classes (e.g., concrete instruction selectors 150 and 155) that inherit from InstructionSelector to implement this method, during which time they will instantiate their target-specific InstructionTile-derived objects (the concrete instruction tiles) and invoke the addTile ( ) method to add them to the tile set. Described in another way, a concrete instruction selector implements a method to assemble or gather the concrete instruction tiles, for a selected architecture, into the tile set to be used by the instruction selector in performing the pattern matching and instruction generation of the compiler of the present invention.

The steps involved in retargeting the instruction selection framework to a new hardware or assembly language platform are as follows:

1. Define new concrete instruction tiles for the selected architecture or platform, as InstructionTile-derived classes (e.g., concreteInstructionTile1 160 and concreteInstructionTile2 165). These classes will inherit most of their behavior from abstract InstructionTile-derived classes, such as the function (abstract instruction) tiles and the instruction tile (120).

2. Implement the emitCode ( ) method for each new InstructionTile-derived class (the concrete instruction tiles). This method will emit the appropriate assembly (or configuration) instructions required to implement the operations or functions described by that tile (or its parent function tile) on the target platform.

3. Define a new concrete instruction selector (InstructionSelector-derived class) (e.g., concreteInstructionSelector1 150 and concreteInstructionSelector2 155). This class will inherit most of its behavior from the abstract InstructionSelector class.

4. Implement the createTileSet ( ) method in the new concrete instruction selector (the InstructionSelector-derived class). This is the sole abstract method that should be implemented in a concrete class in order to retarget this class. This method should instantiate the concrete InstructionTile-derived objects defined in steps 1 and 2, then use the addTile ( ) method provided in the InstructionSelector base class to add these tiles to the concrete instruction tile set for use by the instruction selector.

Referring again to FIG. 4, various symbols are illustrated which have corresponding purposes in the programming arts. A “slanted box” is utilized to indicate “public”, such that the adjacent method or attribute may be freely accessed. A “slanted box with a key” is utilized to indicate “protected”, such that the adjacent method or attribute may be accessed only by another method within the class itself or by another method within another class which inherits from this class. For example, since concreteInstructionSelector1 (150) inherits from InstructionSelector (110), its createTileSet ( ) method can access the base class addTile ( ) method. In contrast, if a concreteInstructionTile1 (160) is instantiated for a particular architecture, it has a myInstructionSelector attribute (inheriting from the abstract instruction tile classes), but cannot call the createTileSet( ) method of Instruction Selector 110. A “padlock with a slanted box” is utilized to indicate “private”, so that the adjacent method or attribute may be accessed only by another method within the class itself. Also for example, the methods of the Instruction Selector class 110 only may access InstructionSelector::myInstructionTiles, for use in the InstructionSelector::addTile and InstructionSelector::generateAssembly methods, which are not overridden by any derived concrete classes.

Exemplary Implementations:

In order to amplify the preceding discussion, three exemplary concrete class implementations are illustrated for different hardware architectures. Each implementation will recognize and generate instructions for the abstract syntax tree illustrated in FIG. 1. Among other things, these examples illustrate, first, different tilings which may occur due to use of a different tile set (e.g., availability of a MAC tile), and second, that the same tiling may occur for different architectures (with the generation of different instructions due to different concrete classes). These exemplary concrete class implementations will target variously the Intel x86 Architecture, the Motorola 68000 Architecture, and the TI TMS320C54x DSP Architecture, respectively, and may be expanded to include other architectures which may be developed, which are also within the scope of the present invention. For example, the compiler of the invention may be targeted to an adaptive, reconfigurable computing architecture, with generation of configuration instructions to direct and control various adaptations, through an interconnection network, for implementing selected functionality (rather than generation of assembly language instructions for a traditional processor). (Such an exemplary reconfigurable computing architecture is illustrated in Paul L. Master et al., U.S. patent application Ser. No. 09/815/122, filed Mar. 22, 2001, entitled “Adaptive Integrated Circuitry With Heterogeneous And Reconfigurable Matrices Of Diverse And Adaptive Computational Units Having Fixed, Application Specific Computational Elements”, incorporated herein by this reference).

A. Exemplary Implementations of Abstract Tiles:

All three implementations share a common set of abstract instruction tiles, as well as the abstract InstructionSelector class 110 described above. The implementation of each abstract instruction tile is discussed below.

MoveTile:

The MoveTile class (125) recognizes movement of data from one location to another, thereby recognizing a MOVE node (or MOVE statement) as illustrated in FIGS. 1 and 2. An exemplary implementation of the MoveTile abstract class is:

public abstract class MoveTile extends InstructionTile
{

public MoveTile(InstructionSelector anInstructionSelector)
{

super(anInstructionSelector);

}
public boolean doesMatch(AbstractSyntaxTree aSubTree)
{

if (aSubTree instanceof MoveStatement)
{

return true;

}
return false;

}
protected int getSize( )
{

return 1;

}

}

TempTile:

The TempTile class (135) recognizes data that is stored in some variable, thereby recognizing a TEMP node (or TEMP statement) as illustrated in FIGS. 1 and 2 (with four TEMP nodes). An exemplary implementation of the TempTile abstract class is:

public abstract class TempTile extends InstructionTile
{

public TempTile (InstructionSelector anInstructionSelector)
{

super(anInstructionSelector);

}
public boolean doesMatch (AbstractSyntaxTree aSubTree)
{

if (aSubTree instanceof TempExpression)
{
return true;

}
return false;

}
protected int getSize( )
{

return 1;

}

}

BinaryOperationTile:

The BinaryoperationTile class (130) recognizes a mathematical operation performed on two operands. It acts as the base (or parent) class for any binary operation with two arguments, such as the AddTile and MultTile classes (145 and 140) that will be described below, and as illustrated in FIGS. 1, 2 and 4. An exemplary implementation of the BinaryoperationTile abstract class is:

public abstract class BinaryOperationTile extends InstructionTile
{

public BinaryOperationTile (InstructionSelector
anInstructionSelector)
{

super(anInstructionSelector);

}
public boolean doesMatch (AbstractSyntaxTree aSubTree)
{

if (aSubTree instanceof BinaryOperationExpression)
{

return true;

}
return false;

}
protected int getSize( )
{

return 1;

}

}

AddTile:

The AddTile class (145) recognizes an addition operation performed on two operands as illustrated in FIG. 2. It further refines the functionality (or behavior) of its base class BinaryOperationTile. An exemplary implementation of the AddTile abstract class is:

public abstract class AddTile extends BinaryOperationTile
{

public AddTile(InstructionSelector anInstructionSelector)
{

super(anInstructionSelector);

}
public boolean doesMatch(AbstractSyntaxTree aSubTree)
{

if (!super.doesMatch( ))
{

return false;

}
BinaryOperationExpression binaryOperation =

(BinaryOperationExpression) aSubTree;

if (binaryOperation.getoperation( ) ==

BinaryOperationExpression::ADD)

{

return true;

}
return false;

}
protected int getSize( )
{

return 1;

}

}

MultTile:

The MultTile class recognizes a multiplication operation performed on two operands as illustrated in FIG. 2. It further refines the functionality of its base class BinaryoperationTile. An exemplary implementation of the MultTile abstract class is:

public abstract class MultTile extends BinaryOperationTile
{

public MultTile(InstructionSelector anInstructionSelector)
{

super(anInstructionSelector);

}
public boolean doesMatch(AbstractSyntaxTree aSubTree)
{

if (!super.doesMatch( ))
{

return false;

}
BinaryOperationExpression binaryOperation =

(BinaryOperationExpression) aSubTree;

if (binaryOperation.getOperation( ) ==

BinaryOperationExpression::MULT)

{

return true;

}
return false;

}
protected int getSize( )
{

return 1;

}

}

It should be noted for the exemplary implementations of the ADD and MULT tiles that the parent class, the BinaryoperationsTile, is expressed as part of the “does match” function of its “super” (parent) class, returning “true” if binary operation matches, further returning true if correspondingly “ADD” or “MULT” match, and returning “false” otherwise. Similar code expressions for the matching functionality may be found in the other abstract tiles illustrated above and further below.

MACTile:

The MACTile class recognizes a Multiply-And-Accumulate (MAC) operation as illustrated in FIG. 3, recognizing much of the abstract syntax tree as one tile. It is a composite of multiply, add and move operations and may not be supported on all architectures. In our examples, only the TI TMS320C54x DSP architecture makes use of this abstract tile. MACTile further refines the behavior of its base class MoveTile. An exemplary implementation of the MACTile abstract class is:

public abstract class MACTile extends MoveTile
{

public MACTile (InstructionSelector anInstructionSelector)
{

super(anInstructionSelector);

}
public boolean doesMatch(AbstractSyntaxTree aSubTree)
{

if (!super.doesMatch(aSubTree))
{

return false;

}
MoveStatement moveStatement = (MoveStatement) aSubTree;
AbstractSyntaxTree destination =

moveStatement.getDestination(aSubTree);

if (!destination instanceof TempExpression)
{

return false;

}
AbstractSyntaxTree source =

moveStatement.getSource(aSubTree);

if (!source instanceof BinaryOperationExpression)
{

return false;

}
BinaryOperationExpression binaryOperation =

(BinaryOperationExpression) source;

if (binaryOperation.getOperation( ) !=

BinaryOperationExpression::ADD)

{

return false;

}
if (binaryOperation.getLeftOperand( ) != destination)
{

return false;

}
AbstractSyntaxTree rightOperand =

BinaryOperation.getRightOperand( );

if (!rightOperand instanceof BinaryOperationExpression)
{

return false;

}
if ((BinaryOperationExpression)

rightOperand).getOperation( ) !=
BinaryOperationExpression::MULT)

{

return false;

}
return true;

}
protected int getSize( )
{

return 5;

}

}

B. Exemplary Implementations of Concrete Tiles:

The exemplary concrete tiles presented below utilize or incorporate three exemplary classes, Instruction, InstructionList, and Temp, and may be briefly explained for understanding the exemplary code illustrated below. The Instruct ion class stores a textual representation of its corresponding assembly language instruction. The InstructionList class aggregates multiple Instruction objects. It also provides access to the location where the result of executing its aggregate instructions can be found. This location is accessed through the InstructionList::getResultLocation( ) and InstructionList::setResultLocation( ) methods. The Temp class represents a program variable. For the purposes of the examples below, it is assumed to have a method, Temp::getLocation ( ), that will return the memory address or register where this variable will be located on the target architecture. This simplification is included for the sake of demonstration, as a complete implementation would include an Optimizer (discussed above) that would determine the location of all program variables after the generation of the assembly code, as well as removing unnecessary move instructions, among other functions.

These various concrete tiles are provided as examples for illustrating the retargeting capability of the present invention, while using the same (or similar) abstract classes (or tiles) of the compiler.

It should be noted that discussion concerning a particular concrete tile will also be generally applicable to other concrete tiles of the corresponding architecture.

1. Concrete Tiles for Intel x86 Architecture:

The Intel x86 Architecture has comparatively few general-purpose registers and, as a consequence, the exemplary concrete instruction tiles for this architecture make no attempt to assign program variables to registers. Instead, variables are moved in and out of memory through the AX register, using general destination and source addressing, respectively. Addition operations are performed using the ADD instruction, while multiplication operations are performed using MUL, and the Multiply-Accumulate (MAC) tile is not implemented for this architecture.

IntelMoveTile:

An exemplary IntelMoveTile generates a set of two assembly language instructions of the form:

MOV AX, [sourceaddress]

MOV [destinationaddress], AX

An exemplary implementation of this concrete tile is:

public class IntelMoveTile extends MoveTile
{

public InstructionList emitCode(AbstractSyntaxTree aSubTree)
{

MoveStatement moveStatement = (MoveStatement) aSubTree;
InstructionList sourceInstructions =

myInstructionSelector.generateAssembly(

MoveStatement.getSource( ));

InstructionList destinationInstructions =

myInstructionSelector.generateAssembly(

MoveStatement.getDestination( ));

Instruction loadInstruction = new Instruction(

“MOV AX, ” +

sourceInstructions.getResultLocation( ));
Instruction storeInstruction = new Instruction(

“MOV ” +

destinationInstructions.getResultLocation( ) +

“, AX”);

InstructionList instructions = new InstructionList;
instructions.add(sourceInstructions);
instructions.add(destinationInstructions);
instructions.add(loadInstruction);
instructions.add(storeInstruction);
instructions.setResultLocation(

destinationInstructions.getResultLocation( ));

return instructions;

}

}

As illustrated, and as may be extended to the other illustrated tiles, the brackets “[ ]” indicate memory rather than register addressing, with the move occurring from memory to a register and then to memory; the tile begins with a declaration that it is a subclass of and inherits from MoveTile; source and destination instructions are determined and emitted, followed by emitting the move instructions, all for this target hardware architecture.

IntelTempTile:

An exemplary IntelTempTile generates no assembly language instructions, but records the address of the program variable being referenced, for use by another class or tile, such as a move tile, with brackets also indicating a memory location. An exemplary implementation of this concrete tile is:

public class IntelTempTile extends TempTile
{

public InstructionList emitCode(AbstractSyntaxTree aSubTree)
{

TempExpression tempExpression = (TempExpression) aSubTree;
instructions.setResultLocation(“[” +

tempExpression.getTemp( ).getLocation( ) + “]”);

return instructions;

}

}

IntelAddTile:

An exemplary IntelAddTile generates a set of three assembly language instructions of the form:

MOV AX, [left-operand-address]

ADD AX, [right-operand-address]

MOV [temp-result-address],AX

providing that a left-side operand will be moved into a register, adding to that register a right-side operand, and moving the result into another memory location. An exemplary implementation of this concrete tile is:

public class IntelAddTile extends AddTile

{

public InstructionList emitCode(AbstractSyntaxTree aSubTree)
{

BinaryOperationExpression expression =

(BinaryOperationExpression) aSubTree;

InstructionList lhsInstructions =

myInstructionSelector.generateAssembly(

expression.getLeftOperand( ));

InstructionList rhsInstructions =

myInstructionSelector.generateAssembly(

expression.getRightOperand( ));

Instruction loadInstruction = new Instruction(

“MOV AX, ” +
lhsInstructions.getResultLocation( ));

Instruction addInstruction = new Instruction(

“ADD AX, ” +
rhsInstructions.getResultLocation( ));

Temp tempForResult = new Temp( );
Instruction storeInstruction = new Instruction(

“MOV [” + tempForResult.getLocation( ) + “], AX”);

InstructionList instructions = new InstructionList;
instructions.add(lhsInstructions);
instructions.add(rhsInstructions);
instructions.add(loadInstruction);
instructions.add(addInstruction);
instructions.add(storeInstruction);
instructions.setResultLocation(“[” +

tempForResult.getLocation( ) + “]”);

return instructions;

}

}

IntelMultTile:

An exemplary IntelMultTile generates a set of three assembly language instructions of the form:

MOV AX, [left-operand-address]

MUL [right-operand-address]

MOV [temp-result-address],AX

An exemplary implementation of this concrete tile is:

public class IntelMultTile extends MultTile
{

public InstructionList emitCode (AbstractSyntaxTree aSubTree)
{

BinaryOperationExpression expression =

(BinaryOperationExpression) aSubTree;

InstructionList lhsInstructions =

myInstructionSelector.generateAssembly(

expression.getLeftOperand( ));

InstructionList rhsInstructions =

myInstructionSelector.generateAssembly(

expression.getRightOperand( ));

Instruction loadInstruction = new Instruction(

“MOV AX, ” +
lhsInstructions.getResultLocation( ));

Instruction multInstruction = new Instruction(

“MUL ” +
rhsInstructions.getResultLocation( ));

Temp tempForResult = new Temp( );
Instruction storeInstruction = new Instruction(

“MOV [” + tempForResult.getLocation( ) + “], AX”);

InstructionList instructions = new InstructionList;
instructions.add(lhsInstructions);
instructions.add(rhsInstructions);
instructions.add(loadInstruction);
instructions.add(multInstruction);
instructions.add(storeInstruction);
instructions.setResultLocation(“[” +

tempForResult.getLocation( ) + “]”);

return instructions;

}

}

Concrete Instruction Selector for Intel x86 Architecture:

An exemplary Intel InstructionSelector class is shown below. It instantiates the concrete tiles required to recognize the abstract syntax tree 15 presented in FIG. 1 and to emit instructions for the Intel x86 Architecture. In this instance, it instantiates the MOVE, TEMP, ADD and MULT tiles, through the createTileSet( ) method. An exemplary implementation of this concrete tile is:

public class IntelInstructionSelector extends InstructionSelector

{
public IntelInstructionSelector( )
{

super( );

}
protected void createTileSet( )
{

this.addInstructionTile(new IntelTempTile(this));
this.addInstructionTile(new IntelMoveTile(this))
this.addInstructionTile(new IntelAddTile(this));
this.addInstructionTile(new IntelMultTile(this))

}

}

2. Concrete Tiles for Motorola 68000 Architecture:

The Motorola 68000 Architecture has comparatively many general-purpose registers and, as a consequence, the concrete instruction tiles for this architecture assume program variables will be assigned to registers and not to memory. The D0 register is used to store the result of a computation. Addition operations are performed using the ADD instruction, while multiplication operations are performed using MULS, and a Multiply-Accumulate (MAC) tile is not implemented for this architecture.

MotorolaMoveTile:

An exemplary MotorolaMoveTile generates a single assembly language instruction of the form:

MOV destinationregister, sourceregister

An exemplary implementation of this concrete tile is:

public class MotorolaMoveTile extends MoveTile
{

public InstructionList emitCode(AbstractSyntaxTree aSubTree)
{

MoveStatement moveStatement = (MoveStatement) aSubTree;
InstructionList sourceInstructions =

myInstructionSelector.generateAssembly(

MoveStatement.getSource( ));

InstructionList destinationInstructions =

myInstructionSelector.generateAssembly(

MoveStatement.getDestination( ));

Instruction moveInstruction = new Instruction(

“MOV ” +
destinationInstructions.getResultLocation( ) +
“, ” + sourceInstructions.getResultLocation( ));

InstructionList instructions = new InstructionList;
instructions.add(sourceInstructions);
instructions.add(destinationInstructions);
instructions.add(moveInstruction);
instructions.setResultLocation(

destinationInstructions.getResultLocation( ));

return instructions;

}

}

As illustrated, brackets “[ ]” are not needed, as register addressing may be utilized, with the move occurring directly between registers; the tile begins with a declaration that it is a subclass of and inherits from MoveTile; register source and destination instructions are determined and emitted, followed by emitting the move instructions, all for this different target hardware architecture.

MotorolaTempTile:

An exemplary MotorolaTempTile generates no assembly language instructions, but records the register of the program variable being referenced, also for use by another class or tile, such as a move tile (but with no need for brackets indicating a memory location, as registers are utilized). An exemplary implementation of this concrete tile is:

public class MotorolaTempTile extends TempTile
{

public InstructionList emitCode(AbstractSyntaxTree aSubTree)
{

TempExpression tempExpression = (TempExpression) aSubTree;
InstructionList instructions = new InstructionList;
instructions.setResultLocation(

tempExpression.getTemp( ).getLocation( ));

return instructions;

}

}

MotorolaAddTile:

An exemplary MotorolaAddTile generates a set of three assembly language instructions of the form:

MOV D0, left-operand-register

ADD D0, right-operand-register

MOV temp-result-register, D0

providing that a left-side operand is in a register, adding to that register a right-side operand, and moving the result into another register. An exemplary implementation of this concrete tile is:

public class MotorolaAddTile extends AddTile
{

public InstructionList emitCode(AbstractSyntaxTree aSubTree)
{

BinaryOperationExpression expression =

(BinaryOperationExpression) aSubTree;

InstructionList lhsInstructions =

myInstructionSelector.generateAssembly(

expression.getLeftOperand( ));

InstructionList rhsInstructions =

myInstructionSelector.generateAssembly(

expression.getRightOperand( ));

Instruction loadInstruction = new Instruction(

“MOV D0, ” +
lhsInstructions.getResultLocation( ));

Instruction addInstruction = new Instruction(

“ADD D0, ” +
rhsInstructions.getResultLocation( ));

Temp tempForResult = new Temp( );
Instruction storeInstruction = new Instruction(

“MOV ” + tempForResult.getLocation( ) + “, D0”);

InstructionList instructions = new InstructionList;
instructions.add(lhsInstructions);
instructions.add(rhsInstructions);
instructions.add(loadInstruction);
instructions.add(addInstruction);
instructions.add(storeInstruction);
instructions.setResultLocation(

tempForResult.getLocation( ));

return instructions;

}

}

MotorolaMultTile:

An exemplary MotorolaMultTile generates a set of three assembly language instructions of the form:

MOV D0, left-operand-register

MULS D0, right-operand-register

MOV temp-result-register, D0

An exemplary implementation of this concrete tile is:

public class MotorolaMultTile extends MultTile
{

public InstructionList emitCode(AbstractSyntaxTree aSubTree)
{

BinaryOperationExpression expression =

(BinaryOperationExpression) aSubTree;

InstructionList lhsInstructions =

myInstructionSelector.generateAssembly(

expression.getLeftOperand( ));

InstructionList rhsInstructions =

myInstructionSelector.generateAssembly(

expression.getRightOperand( ));

Instruction loadInstruction = new Instruction(

“MOV D0, ” +
lhsInstructions.getResultLocation( ));

Instruction multInstruction = new Instruction(

“MULS D0, ” +
rhsInstructions.getResultLocation( ));

Temp tempForResult = new Temp( );
Instruction storeInstruction = new Instruction(

“MOV ” + tempForResult.getLocation( ) + “, D0”);

InstructionList instructions = new InstructionList;
instructions.add(lhsInstructions);
instructions.add(rhsInstructions);
instructions.add(loadInstruction);
instructions.add(multInstruction);
instructions.add(storeInstruction);
instructions.setResultLocation(

tempForResult.getLocation( ));

return instructions;

}

}

Instruction Selector for the Motorola 68000 Architecture:

An exemplary MotorolaInstructionSelector class is shown below. It instantiates the concrete tiles required to recognize the abstract syntax tree presented in FIG. 1 and to emit instructions for the Motorola 68000 Architecture. In this instance, it instantiates the MOVE, TEMP, ADD and MULT tiles, through the createTileSet ( ) method. An exemplary implementation of this concrete tile is:

public class MotorolaInstructionSelector extends InstructionSelector
{

public MotorolaInstructionSelector( )
{

super( );

}
protected void createTileSet( )
{

this.addInstructionTile(new MotorolaTempTile(this));
this.addInstructionTile(new MotorolaMoveTile(this));
this.addInstructionTile(new MotorolaAddTile(this));
this.addInstructionTile(new MotorolaMultTile(this));

}

}

3. Concrete Tiles for Texas Instruments (TI) TMS320C54x DSP Architecture:

The TI TMS320C54x DSP Architecture has comparatively few general-purpose registers, and as a consequence, the concrete instruction tiles for this architecture make no attempt to assign program variables to registers. Instead, variables are moved in and out of memory. Note that the Multiply-Accumulate (MAC) tile is implemented for this architecture instead of the MOVE, ADD and MULT tiles.

TITempTile:

An exemplary TITempTile generates no assembly language instructions, but records the address of the program variable being referenced. An exemplary implementation of this concrete tile is:

public class TITempTile extends TempTile
{

public InstructionList emitcode(AbstractSyntaxTree aSubTree)
{

TempExpression tempExpression = (TempExpression) aSubTree;
InstructionList instructions = new InstructionList;
instructions.setResultLocation(“#” +

tempExpression.getTemp( ).getLocation( ) + “h”);

return instructions;

}

}

TIMACTile:

An exemplary TIMACTile generates a set of three assembly language instructions of the form:

LD A, result-variable-address

MAC left-operand-address, right-operand-address, A

STL A, result-variable-address

An exemplary implementation of this concrete tile is:

public class TIMACTile extends MACTile
{

public InstructionList emitCode(AbstractSyntaxTree aSubTree)
{

MoveStatement moveStatement =

(MoveStatement) aSubTree;

InstructionList destInstructions =

myInstructionSelector.generateAssembly(

moveStatement.getDestination( ));

BinaryOperationExpression expression =

(BinaryOperationExpression)
moveStatement.getSource( );

BinaryOperationExpression multExpression =

(BinaryOperationExpression)
expression.getRightOperand( );

InstructionList lhsInstructions =

myInstructionSelector.generateAssembly(

multExpression.getLeftOperand( ));

InstructionList rhsInstructions =

myInstructionSelector.generateAssembly(

multExpression.getRightOperand( ));

Instruction loadInstruction = new Instruction(

“LD A, ” +
destInstructions.getResultLocation( ));

Instruction macInstruction = new Instruction(

“MAC ” +
lhsInstructions.getResultLocation( ) + “, ” +
rhsInstructions.getResultLocation( ) + “, A”);

Instruction storeInstruction = new Instruction(

“STL A, ” + destInstructions.getResultLocation( ));

InstructionList instructions = new InstructionList;
instructions.add(lhsInstructions);
instructions.add(rhsInstructions);
instructions.add(destInstructions);
instructions.add(loadInstruction);
instructions.add(macInstruction);
instructions.add(storeInstruction);
instructions.setResultLocation(

destInstructions.getResultLocation( ));

return instructions;

}

}

Concrete Instruction Selector for the TI TMS320C54x DSP Architecture:

An exemplary TIInstructionSelector class is shown below. It instantiates the concrete tiles required to recognize the abstract syntax tree presented in FIG. 1 and to emit instructions for the TI TMS320C54x DSP Architecture. It is similar to the other concrete instruction selectors illustrated above, but with references to the TI-specific tiles. An exemplary implementation of this concrete tile is:

public class TIInstructionSelector extends InstructionSelector
{

public TIInstructionSelector ( )
{

super( );

}
protected void createTileSet( )
{

this.addInstructionTile(new TITempTile(this));
this.addInstructionTile(new TIMACTile(this));

}

}

C. Comparison of Generated Assembly Code:

The corresponding assembly code generated by the compiler of the present invention, for the abstract syntax tree illustrated in FIG. 1, for each of the exemplary architectures, is

Generated Assembly Code for the Intel x86 Architecture:

;

; The following memory address assignments are assumed:

; a-[0000]

; b-[0001]

; c-[0002]

; temp1-[0003]

; temp2-[0004]

MOV AX, [0001]

MUL [0002]

MOV [0003], AX

MOV AX, [0000]

ADD AX, [0003]

MOV [0004], AX

MOV AX, [0004]

MOV [0000], AX

Generated Assembly Code for the Motorola 68000 Architecture:

;

; The following register assignments are assumed:

; a-D1

; b-D2

; c-D3

; temp1-D4

temp2-D5

MOV D0, D2

MULS D0, D3

MOV D4, D0

MOV D0, D1

ADD D0, D4

MOV D5, D0

MOV D1, D5

Generated Assembly Code for the TI TMS320C54x DSP Architecture:

;

; The following memory address assignments are assumed:

; a-#0100h

; b-#1000h

; c-#2000h

LD #0100h, A

MAC #1000h, #2000h, A

STL A, #0100h

As may be apparent from the illustrated assembly code (assembly language) examples, the Motorola and Intel assembly code sections differ primarily with respect to register and memory usage, and are very similar in length (7 lines and 8 lines, respectively). The greater contrast occurs in the code for the DSP architecture, which apart from operand locations, utilizes a single MAC instruction, and does not require the separate move, add and multiply steps, resulting in only 3 lines of code.

Significantly, the assembly code for each of these different architectures may be generated with the single, retargetable compiler of the present invention, utilizing virtually all of the same abstract classes (with the one exception noted above) for implementation of the matching algorithm, with corresponding and independent concrete classes utilized merely for the specific code generation aspect.

The compiler may be embodied in any number of forms, such as within a computer, within a workstation, or within any other form of computing or other system used to compile source code into some form of instructions (including assembly language instructions or configuration information for adaptive computing). The compiler may be embodied as any type of software, such as C++, C#, Java, or any other type of programming language. The compiler may be embodied within any tangible storage medium, such as within a memory or storage device for use by a computer, a workstation, any other machine-readable medium or form, or any other storage form or medium for use in a computing system to compile source code into some form of instructions. Such storage medium, memory or other storage devices may be any type of memory device, memory integrated circuit (“IC”), or memory portion of an integrated circuit (such as the resident memory within a processor IC), including without limitation RAM, FLASH, DRAM, SRAM, MRAM, FeRAM, ROM, EPROM or E²PROM, or any other type of memory, storage medium, or data storage apparatus or circuit, depending upon the selected embodiment. For example, without limitation, a tangible medium storing computer readable software, or other machine-readable medium, may include a floppy disk, a CDROM, a CD-RW, a magnetic hard drive, an optical drive, a quantum computing storage medium or device, a transmitted electromagnetic signal (e.g., used in internet downloading), or any other type of data storage apparatus or medium.

In summary the invention provides a compiler, a method of compiling, and a method for creating a compiler, for generating instructions from source code for a first integrated circuit architecture of a plurality of different integrated circuit architectures. The source code is capable of being represented as a plurality of nodes of an abstract syntax tree. The compiler and methods may also be targeted to a second integrated circuit architecture, or to a third integrated circuit architecture, of a plurality of different integrated circuit architectures.

The method of the invention comprises performing a matching function for the plurality of nodes by iteratively calling a corresponding matching operation of a concrete instruction tile of a first plurality of concrete instruction tiles. The first plurality of concrete instruction tiles are formed as concrete classes extending a corresponding plurality of abstract function tiles formed as abstract classes. Each abstract function tile of the plurality of abstract function tiles represents a selected function, and implements the corresponding matching operation. When a concrete instruction tile (of the first plurality of concrete instruction tiles) has been matched to a node of the plurality of nodes (or, equivalently, when a function tile or the corresponding function or pattern has been matched to a node), the method calls a corresponding instruction generation function of the matched concrete instruction tile to generate an instruction for the first integrated circuit architecture (of a plurality of integrated circuit architectures).

For a second architecture, the method performs the matching function for the plurality of nodes by iteratively calling the corresponding matching operation of a concrete instruction tile of a second plurality of concrete instruction tiles. The second plurality of concrete instruction tiles are also formed as concrete classes extending the corresponding plurality of abstract function tiles for a second integrated circuit architecture of the plurality of integrated circuit architectures. When a concrete instruction tile (of the second plurality of concrete instruction tiles) has been matched to a node of the plurality of nodes (or, equivalently, when a function tile or the corresponding function or pattern has been matched to a node), the method calls a corresponding instruction generation function of the matched concrete instruction tile to generate an instruction for the second integrated circuit architecture.

Also in summary, the invention includes a compiler for generating assembly or configuration instructions from source code for a first integrated circuit architecture of a plurality of integrated circuit architectures. The source code is also capable of representation as a plurality of nodes of an abstract syntax tree. The compiler comprises an instruction selector, a plurality of function tiles, and a first plurality of concrete instruction tiles corresponding to (and inheriting from) the plurality of function tiles. The instruction selector is formed as an abstract class and is capable of performing a matching function for the plurality of nodes, generally as part of a larger, instruction generation process. A plurality of function tiles are formed as abstract classes, with each function tile of the plurality of function tiles representing a corresponding function and capable of performing a matching operation for the corresponding function. The first plurality of concrete instruction tiles are formed as concrete classes corresponding to the plurality of function tiles and instantiating the matching operations of the corresponding plurality of function tiles. Each concrete instruction tile of the first plurality of concrete instruction tiles is capable of generating an instruction for the first integrated circuit architecture when a corresponding function has been matched to a node of the plurality of nodes.

The instruction selector is capable of performing the matching function by iteratively calling corresponding matching operations of the plurality of concrete instruction tiles inherited from the corresponding plurality of function tiles. The instruction selector is further capable of performing instruction generation, when the corresponding matching operation of a concrete instruction tile of the plurality of concrete instruction tiles indicates that a corresponding function has been matched to a node of the plurality of nodes, by calling an instruction generation function of the corresponding concrete instruction tile. (It should be noted that the distinction in terminology, between matching function and matching operation, is utilized herein solely to distinguish which class is performing the matching and how, namely, the pattern matching performed through the instruction selector (matching function) as part of its larger instruction generation function, which occurs by calling the matching operations (Boolean matching function (boolean doesMatch( )) of the function tiles (as inherited by the construction tiles), which then determine the existence of a pattern match.)

In extending the compiler to other architectures, such as a second integrated circuit architecture, the invention utilizes a second plurality of concrete instruction tiles, also formed as concrete classes corresponding to the plurality of function tiles and instantiating the matching operations of the corresponding plurality of function tiles. Each concrete instruction tile of the second plurality of concrete instruction tiles is capable of generating an instruction for a second integrated circuit architecture, of the plurality of integrated circuit architectures, when a corresponding function has been matched to a node of the plurality of nodes.

The various pluralities of concrete instruction tiles are generated using corresponding concrete instruction selectors, for the corresponding selected architectures. Each concrete instruction selector, implemented as a concrete class, extends the instruction selector to a selected integrated circuit architecture of the plurality of integrated circuit architectures, and is capable of implementing the tile set generation function by determining the plurality of concrete instruction tiles for the corresponding integrated circuit architecture.

Numerous advantages of the present invention may be readily apparent. The instruction selector framework uses object-oriented design and implementation techniques to facilitate retargeting of an instruction selector to multiple hardware and assembly instruction or configuration instruction targets. This is accomplished by dividing the work of the instruction selection process between abstract and concrete classes. The abstract classes provide the bulk of the functionality required to perform instruction selection. These classes are independent of the target architecture, and can be reused across all instruction selection implementations. Thus, when retargeting the instruction selector, the only required changes are in the implementation of the concrete classes and the tile set creation method. This results in a considerable savings in design and development time, and results in more robust and reliable code.

From the foregoing, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

It is claimed:

1. A compiler for generating instructions from source code for a first integrated circuit architecture of a plurality of integrated circuit architectures, the source code capable of representation as a plurality of nodes of an abstract syntax tree, the compiler comprising:
an instruction selector formed as an abstract class, the instruction selector capable of performing a matching function for the plurality of nodes;
a plurality of function tiles formed as abstract classes, each function tile of the plurality of function tiles representing a corresponding function and capable of performing a matching operation for the corresponding function; and
a first plurality of concrete instruction tiles formed as concrete classes corresponding to the plurality of function tiles and instantiating the matching operations of the corresponding plurality of function tiles, each concrete instruction tile of the first plurality of concrete instruction tiles capable of generating an instruction for the first integrated circuit architecture when a corresponding function has been matched to a node of the plurality of nodes.

2. The compiler of claim 1, wherein the instruction selector is capable of performing the matching function by iteratively calling corresponding matching operations of the plurality of concrete instruction tiles inherited from the corresponding plurality of function tiles.

3. The compiler of claim 2, wherein the instruction selector is further capable of performing instruction generation, when the corresponding matching operation of a concrete instruction tile of the plurality of concrete instruction tiles indicates that a corresponding function has been matched to a node of the plurality of nodes, by calling an instruction generation function of the corresponding concrete instruction tile.

4. The compiler of claim 1, further comprising:
a second plurality of concrete instruction tiles formed as concrete classes corresponding to the plurality of function tiles and instantiating the matching operations of the corresponding plurality of function tiles, each concrete instruction tile of the second plurality of concrete instruction tiles capable of generating an instruction for a second integrated circuit architecture, of the plurality of integrated circuit architectures, when a corresponding function has been matched to a node of the plurality of nodes.

5. The compiler of claim 1, wherein the instruction selector is further capable of performing a tile set generation function.

6. The compiler of claim 5, further comprising:
a first concrete instruction selector formed as a concrete class extending the instruction selector to the first integrated circuit architecture, the first concrete instruction selector capable of implementing the tile set generation function by determining the first plurality of concrete instruction tiles for the first integrated circuit architecture.

7. The compiler of claim 5, further comprising:
a second concrete instruction selector formed as a concrete class extending the instruction selector to a second integrated circuit architecture of the plurality of integrated circuit architectures, the second concrete instruction selector capable of implementing the tile set generation function by determining a second plurality of concrete instruction tiles for the second integrated circuit architecture.

8. The compiler of claim 1, further comprising:
an instruction tile formed as an abstract class and as a base class of the plurality of function tiles, the instruction tile capable of declaring a plurality of operations for use by the plurality of function tiles, the plurality of concrete instruction tiles, and the instruction selector.

9. The compiler of claim 8, wherein the plurality of operations comprise a Boolean matching operation and an instruction generation function.

10. The compiler of claim 9, wherein the plurality of operations further comprise a tile size function and a compare function for the instruction selector to sort the plurality of concrete instruction tiles in order of descending size.

11. The compiler of claim 9, wherein the instruction selector is capable of performing the matching function by iterating over the plurality of concrete instruction tiles and calling the Boolean matching operations of the plurality of concrete instruction tiles inherited from the corresponding plurality of function tiles and, when a match of a concrete instruction tile to a node has occurred, by calling the instruction generation function of the corresponding concrete instruction tile.

12. The compiler of claim 8, wherein the first plurality of concrete instruction tiles are extensions of and inherit from the corresponding plurality of function tiles.

13. The compiler of claim 1, wherein the first integrated circuit architecture is a processor having a fixed structure, and wherein the generated instructions are assembly language instructions.

14. The compiler of claim 1, wherein the first integrated circuit architecture is an adaptive computing architecture, and wherein the generated instructions are configuration instructions capable of reconfiguring an interconnection network of the adaptive computing architecture for a selected functionality.

15. The compiler of claim 1, wherein the compiler is stored in a machine-readable medium.

16. A method of compiling for generating instructions from source code for a first integrated circuit architecture of a plurality of integrated circuit architectures, the source code capable of representation as a plurality of nodes of an abstract syntax tree, the method comprising:
performing a matching function for the plurality of nodes by iteratively calling a corresponding matching operation of a concrete instruction tile of a first plurality of concrete instruction tiles, the first plurality of concrete instruction tiles formed as concrete classes extending a corresponding plurality of abstract function tiles, each abstract function tile of the plurality of abstract function tiles representing a selected function and implementing the corresponding matching operation; and
when a concrete instruction tile, of the first plurality of concrete instruction tiles, has been matched to a node of the plurality of nodes, calling a corresponding instruction generation function of the matched concrete instruction tile to generate an instruction for the first integrated circuit architecture.

17. The method of claim 16, further comprising:
performing the matching function for the plurality of nodes by iteratively calling the corresponding matching operation of a concrete instruction tile of a second plurality of concrete instruction tiles, the second plurality of concrete instruction tiles formed as concrete classes extending the corresponding plurality of abstract function tiles for a second integrated circuit architecture of the plurality of integrated circuit architectures.

18. The method of claim 17, further comprising:
when a concrete instruction tile of the second plurality of concrete instruction tiles has been matched to a node of the plurality of nodes, calling a corresponding instruction generation function of the matched concrete instruction tile, of the second plurality of concrete instruction tiles, to generate an instruction for the second integrated circuit architecture.

19. The method of claim 17, further comprising:
determining the second plurality of concrete instruction tiles for the second integrated circuit architecture.

20. The method of claim 16, further comprising:
determining the first plurality of concrete instruction tiles for the first integrated circuit architecture.

21. The method of claim 16, further comprising:
utilizing an instruction tile to declare a plurality of operations for use in performing the matching function and the matching operation, the instruction tile formed as an abstract class and as a base class of the plurality of abstract function tiles.

22. The method of claim 21, wherein the plurality of operations comprise a Boolean matching function and the instruction generation function.

23. The method of claim 22, wherein the plurality of operations further comprise a tile size function and a compare function for sorting the plurality of concrete instruction tiles in order of descending size.

24. The method of claim 16, wherein the first integrated circuit architecture is a processor having a fixed structure, and wherein the generated instructions are assembly language instructions.

25. The method of claim 16, wherein the first integrated circuit architecture is an adaptive computing architecture, and wherein the generated instructions are configuration instructions capable of reconfiguring an interconnection network of the adaptive computing architecture for a selected functionality.

26. A tangible medium storing computer readable software for generating instructions from source code for a first integrated circuit architecture of a plurality of integrated circuit architectures, the source code capable of representation as a plurality of nodes of an abstract syntax tree, the tangible medium storing computer readable software comprising:
first software forming an instruction selector as an abstract class, the instruction selector capable of performing a matching function for the plurality of nodes;
second software forming a plurality of function tiles, each function tile of the plurality of function tiles representing a corresponding function and capable of performing a matching operation for the corresponding function; and
third software forming a first plurality of concrete instruction tiles as concrete classes corresponding to the plurality of function tiles and instantiating the matching operations of the corresponding plurality of function tiles, each concrete instruction tile of the first plurality of concrete instruction tiles capable of generating an instruction for the first integrated circuit architecture when a corresponding function has been matched to a node of the plurality of nodes.

27. The tangible medium storing computer readable software of claim 26, wherein the first software forming the instruction selector is capable of performing the matching function by iteratively calling corresponding matching operations of the plurality of concrete instruction tiles inherited from the corresponding plurality of function tiles.

28. The tangible medium storing computer readable software of claim 27, wherein the first software forming the instruction selector is further capable of performing instruction generation, when the corresponding matching operation of a concrete instruction tile of the plurality of concrete instruction tiles indicates that a corresponding function has been matched to a node of the plurality of nodes, by calling an instruction generation function of the corresponding concrete instruction tile.

29. The tangible medium storing computer readable software of claim 26, further comprising:
fourth software forming a second plurality of concrete instruction tiles as concrete classes corresponding to the plurality of function tiles and instantiating the matching operations of the corresponding plurality of function tiles, each concrete instruction tile of the second plurality of concrete instruction tiles capable of generating an instruction for a second integrated circuit architecture, of the plurality of integrated circuit architectures, when a corresponding function has been matched to a node of the plurality of nodes.

30. The tangible medium storing computer readable software of claim 26, wherein the first software forming the instruction selector is further capable of performing a tile set generation function.

31. The tangible medium storing computer readable software of claim 30, further comprising:
fifth software forming a first concrete instruction selector as a concrete class extending the instruction selector to the first integrated circuit architecture, the first concrete instruction selector capable of implementing the tile set generation function by determining the first plurality of concrete instruction tiles for the first integrated circuit architecture.

32. The tangible medium storing computer readable software of claim 30, further comprising:
sixth software forming a second concrete instruction selector as a concrete class extending the instruction selector to a second integrated circuit architecture of the plurality of integrated circuit architectures, the second concrete instruction selector capable of implementing the tile set generation function by determining a second plurality of concrete instruction tiles for the second integrated circuit architecture.

33. The tangible medium storing computer readable software of claim 26, further comprising:
seventh software forming an instruction tile as an abstract class and as a base class of the plurality of function tiles, the instruction tile capable of declaring a plurality of operations for use by the plurality of function tiles, the plurality of concrete instruction tiles, and the instruction selector.

34. The tangible medium storing computer readable software of claim 33, wherein the plurality of operations comprise a Boolean matching function and an instruction generation function.

35. The tangible medium storing computer readable software of claim 34, wherein the plurality of operations further comprise a tile size function and a compare function for the first software forming the instruction selector to sort the plurality of concrete instruction tiles in order of descending size.

36. The tangible medium storing computer readable software of claim 34, wherein the first software forming the instruction selector is capable of performing the matching function by iterating over the plurality of concrete instruction tiles and calling the Boolean matching operations of the plurality of concrete instruction tiles inherited from the corresponding plurality of function tiles and, when a match of a concrete instruction tile to a node has occurred, by calling the instruction generation function of the corresponding concrete instruction tile.

37. A compiler for generating instructions from source code for a plurality of integrated circuit architectures, the source code capable of representation as a plurality of nodes of an abstract syntax tree, the compiler comprising:
an instruction selector formed as an abstract class, the instruction selector capable of performing a matching function for the plurality of nodes;
a plurality of function tiles formed as abstract classes, each function tile of the plurality of function tiles representing a corresponding function and capable of performing a matching operation for the corresponding function;
a first plurality of concrete instruction tiles formed as concrete classes corresponding to the plurality of function tiles and instantiating the matching operations of the corresponding plurality of function tiles, each concrete instruction tile of the first plurality of concrete instruction tiles capable of generating a first instruction, when a corresponding function has been matched to a node of the plurality of nodes, for a first integrated circuit architecture of the plurality of integrated circuit architectures; and
a second plurality of concrete instruction tiles formed as concrete classes corresponding to the plurality of function tiles and instantiating the matching operations of the corresponding plurality of function tiles, each concrete instruction tile of the second plurality of concrete instruction tiles capable of generating a second instruction, when a corresponding function has been matched to a node of the plurality of nodes, for a second integrated circuit architecture of the plurality of integrated circuit architectures.

38. The compiler of claim 37, wherein:
the instruction selector is capable of performing the matching function by iteratively calling corresponding matching operations of the first plurality of concrete instruction tiles inherited from the corresponding plurality of function tiles; and wherein
the instruction selector is further capable of performing instruction generation for the first integrated circuit architecture, when the corresponding matching operation of a concrete instruction tile of the first plurality of concrete instruction tiles indicates that a corresponding function has been matched to a node of the plurality of nodes, by calling an instruction generation function of the corresponding concrete instruction tile of the first plurality of concrete instruction tiles.

39. The compiler of claim 37, wherein:
the instruction selector is capable of performing the matching function by iteratively calling corresponding matching operations of the second plurality of concrete instruction tiles inherited from the corresponding plurality of function tiles; and wherein
the instruction selector is further capable of performing instruction generation for the second integrated circuit architecture, when the corresponding matching operation of a concrete instruction tile of the second plurality of concrete instruction tiles indicates that a corresponding function has been matched to a node of the plurality of nodes, by calling an instruction generation function of the corresponding concrete instruction tile of the second plurality of concrete instruction tiles.

40. The compiler of claim 37, further comprising:
a first concrete instruction selector formed as a concrete class extending the instruction selector to the first integrated circuit architecture, the first concrete instruction selector capable of implementing a tile set generation function by determining the first plurality of concrete instruction tiles for the first integrated circuit architecture; and
a second concrete instruction selector formed as a concrete class extending the instruction selector to the second integrated circuit architecture, the second concrete instruction selector capable of implementing the tile set generation function by determining the second plurality of concrete instruction tiles for the second integrated circuit architecture

41. The compiler of claim 37, further comprising:
an instruction tile formed as an abstract class and as a base class of the plurality of function tiles, the instruction tile capable of declaring a plurality of operations for use by the plurality of function tiles, the plurality of concrete instruction tiles, and the instruction selector, wherein the plurality of operations comprising one or more of the following functions: a Boolean matching function, an instruction generation function, a tile size function and a compare function.

42. The compiler of claim 41, wherein:
the instruction selector is capable of performing the matching function and an instruction generation function for the first integrated circuit architecture by iterating over the first plurality of concrete instruction tiles and calling the Boolean matching operations of the first plurality of concrete instruction tiles inherited from the corresponding plurality of function tiles and, when a match of a concrete instruction tile to a node has occurred, by calling the instruction generation function of the corresponding concrete instruction tile of the first plurality of concrete instruction tiles; and wherein
the instruction selector is capable of performing the matching function and an instruction generation function for the second integrated circuit architecture by iterating over the second plurality of concrete instruction tiles and calling the Boolean matching operations of the second plurality of concrete instruction tiles inherited from the corresponding plurality of function tiles and, when a match of a concrete instruction tile to a node has occurred, by calling the instruction generation function of the corresponding concrete instruction tile of the second plurality of concrete instruction tiles.

43. The compiler of claim 37, wherein the first integrated circuit architecture is a fixed microprocessor architecture and the generated instructions are microprocessor assembly language instructions, and wherein the second integrated circuit architecture is a fixed digital signal processor architecture and the generated instructions are digital signal processor assembly language instructions.

44. The compiler of claim 37, wherein the first integrated circuit architecture is an adaptive computing architecture, and wherein the generated assembly instructions are configuration instructions capable of reconfiguring an interconnection network of the adaptive computing architecture for a selected functionality.
